(19) United States
(12) Patent Application Publication
(10) Pub. No.: US 2009/0210328 A1
(43) Pub. Date: Aug. 20, 2009

(54) SYSTEM AND METHOD FOR FACILITATING A COMMERCIAL PEER TO PEER NETWORK

(76) Inventors: Oleg Fomenko, London (GB); Patrick John Foreman, London (GB)

Correspondence Address: Digital Distribution Networks Limited, C/- 7 Cockle Lane, Waimari Beach, Christchurch, 8083, omitted

(21) Appl. No.: 12/236,504

(22) Filed: Sep. 24, 2008

(30) Foreign Application Priority Data
Feb. 15, 2008 (GB) 0802739.3

(51) Int. Cl. G06Q 10/00; G06Q 99/00; G06Q 50/00

(52) U.S. Cl. 705/30; 705/1

(57) ABSTRACT

System and methods for monitoring, controlling and generating income from the copying and distribution of all forms of digital content within a membership based network of peer-to-peer clients (10, 12, 20). The system creates a controlled environment where only authorised, legitimate content is distributed and all users pay for legal copies but are in return rewarded for any data packets uploaded. Allocation and usage of uploading clients is controlled and prioritised by the central server (18) in order to optimise performance and download speed for purchaser, share distribution of rewards and incentives among uploading clients and enable the security, validation, reconciliation and authorisation of distributed rewards. The invention provides that users upload local transaction logs to the central server (18) on a delayed basis to optimise utilisation of available bandwidth outside of peak times ensure that real-time data transfers between members are facilitated as quickly as possible.

### FIELD OF THE INVENTION

This invention relates to a system and method for facilitating a commercial peer-to-peer network. Particularly, but not exclusively, the invention relates to a system and method for facilitating the secure control of network traffic and reconciliation of financial payments and rewards in a commercial peer-to-peer network where only authorised content is distributed and where all users purchase legal copies and are rewarded when authorised content is uploaded by them to any other user through the commercial peer-to-peer network.

### BACKGROUND OF THE INVENTION

The invention relates to systems and methods for monitoring, controlling and generating income from the copying and distribution of all forms of digital content within a membership-based network of peer-to-peer clients. The system recognises the existence of a secondary market for digital content which currently consists of the distribution of large quantities of pirate copies of movies, music and other digital content, usually free of charge through a range of peer-to-peer networking applications.

It is advantageous to legitimise this market by creating a controlled environment where only authorised, legitimate content is distributed and all users pay for legal copies and are rewarded in return for any part of a copy which is uploaded by them to any other member through the controlled peer-to-peer network. It is also advantageous to allow the reconciliation of user's account activity logs asynchronously on the commercial peer-to-peer network while optimising use of off-peak bandwidth thus improving customer experience and minimising the disruption caused by such reconciliation.

### OBJECTS OF THE INVENTION

It is an object of this invention to provide a system and method for a centralised computer service which will:
(a) validate the legitimacy and authority of all content exchanged over the network;
(b) validate the legitimacy and authority of all claims for uploading content to the network and all financial and other rewards accrued;
(c) control network traffic in such a way as to balance performance requirements of downloading content to purchasers as quickly as possible with the fair distribution of the opportunity for members to earn rewards by uploading;
(d) provide financial accounting and reconciliation services for all transactions taking place over the network;
(e) provide the facility to reward members for uploading content to other members and charging members for downloading content;
or at least provide the public with a useful choice.

It is a further object of this invention to provide a localised client service consisting of systems and methods which will:
(a) manage and log all downloads from the membership community, tracking all data quantities received and from whom they are received;
(b) manage and log all uploads to the membership community tracking all data quantities sent and to whom they are sent; and
(c) maintain a local account balance and periodically reconcile this with records held on a central server;
(d) provide secure methods of reconciling and auditing local (user-side) and centrally-held (server-side) data.
or at least provide the public with a useful choice.

### SUMMARY OF THE INVENTION

In the first aspect the invention provides a system for facilitating a commercial peer-to-peer network, comprising means for one or more registered members to download content via a central server either for (a) a charge, (b) free of charge or (c) earning credits based on certain criteria including the amount of content uploaded by a member; means for at least part of the downloaded content to be uploaded from one or more members of the community who are connected to the network and hold copies of the authorised content locally on their own machines.

In the second aspect the invention provides a system for facilitating a commercial peer-to-peer network, comprising means to maintain a transaction log for each member of the community with details of activities conducted by the member as part of the network including details of downloaded content and uploaded content; and means to verify the legitimacy of requests to download content prior to commencing upload from members holding copies of the requested content.

In the third aspect the invention provides a system for facilitating a commercial peer-to-peer network, comprising means for one or more members to view a real-time estimation of earned rewards using locally-available upload data prior to a reconciliation of the transaction log with other members via a central server; means to reconcile the transaction logs of one or more members on a central server; means to allocate appropriate credit and debit charges to each account of one or more members to reflect the exact details and volume of content traffic on the transaction log and ensure that each transaction is matched and validated between uploading and downloading members; means to control and prioritise the location of uploading members and the sequence of file parts transmitted for any one file downloaded in real time according to a combination of performance and financial considerations whereby a balance of speed of downloads for buyers and fair distribution of rewards for sellers in a secure environment is maintained; means for the community as a whole to retain all or part of rewards earned by members to fund additional community services.

In the fourth aspect the invention provides a system for facilitating a commercial peer-to-peer network, comprising means for one or more members to send an automated email to non-members recommending them to view content and join or to members or non members recommending any authorised content to trial and eventually purchase; means to track the progress of all such recommendations issued; means to allocate credits or rewards to the issuing member in the event that (a) the third party acts upon the email and views the recommended content on the network or (b) the third party opens a membership account with the facility; or (c) the third party purchases or downloads the recommended content.

In the fifth aspect the invention provides a system for facilitating a commercial peer-to-peer network, comprising means to maintain a detailed transaction log for each item of authorised content which tracks the amount of uploaded content and downloaded content according to date and member; means to maintain an account for each member that has provided authorised content; and means to allocate a credit or debit to the member's account for each complete download of specific content related to that member; means for any member that has provided authorised content to view their account details at any time and view their transaction log with upload and download history and volumes and their current balance with the amount of credits and debits applied to their account.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will be described by way of example only with reference to the drawings, in which:

FIG. 1 is a schematic diagram exemplifying the operation of the invention.

FIG. 2 is a flow diagram illustrating the preferred structure of the invention.

### DETAILED DESCRIPTION OF THE PREFERRED EMBODIMENTS

The invention will be described in relation to the preferred embodiment of the system and method. The invention is a system and method for facilitating, controlling and coordinating commercial exchange of any digital material in peer-to-peer (P2P) networks by means of central server having certain functionality disclosed herein.

While direct connections between individual participants in the network will vary when exchanging digital content which has been split into data packets, the role and functionality of the server will ensure that: (a) only digital material authorised by content owners can enter and be exchanged in the system; (b) every instance of material request and exchange is tracked and ensure that the transaction has commercial value for the digital material owner; (c) each of the participants who provided whole or a part of the requested content to the purchaser/downloader is rewarded proportionately to the share of the material provided, (d) the capacity for members to earn rewards is balanced equitably as far as possible having regard to the need to maximise performance and minimise download time for purchasers, (e) means to control and prioritise the location of uploading members and the sequence of file parts transmitted for any one file downloaded in real time according to a combination of performance and financial considerations, and (f) the reconciliation of members' accounts occurs on a delayed basis in order to minimise disruption to data transfer between members.

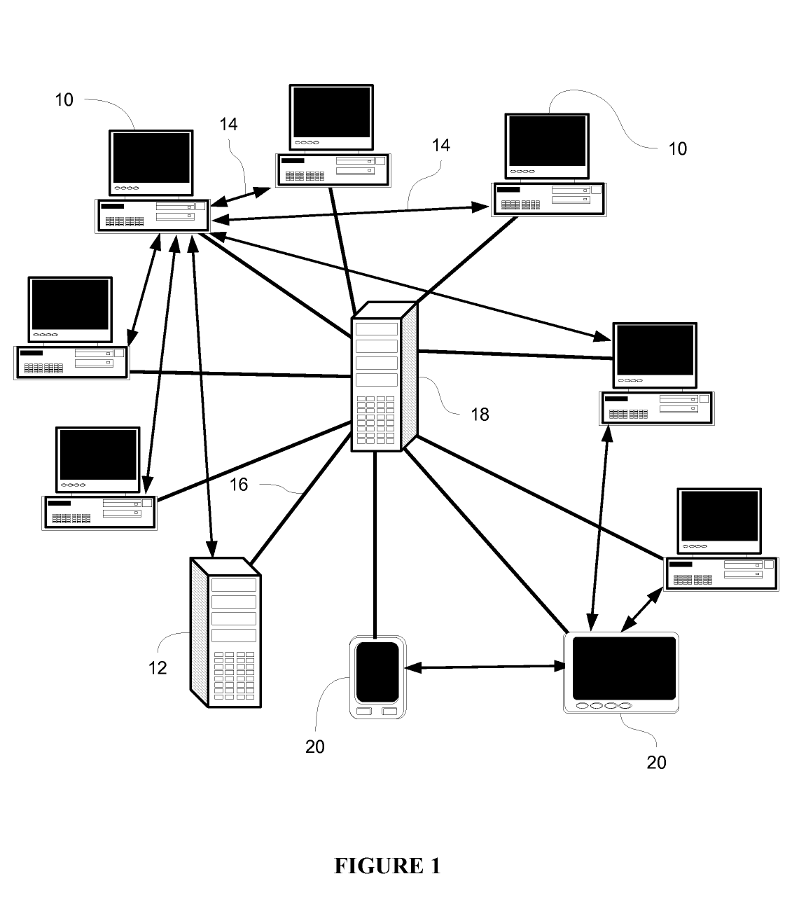

FIG. 1 exemplifies one possible structure of the invention that allows the operation of its described features i.e. a P2P network comprising peripheral devices such as but not limited to personal computers 10, servers 12, and tablet devices 20 connected to the other devices on the P2P network through P2P connections 14 and connected to the central server 18 through direct connections 16.

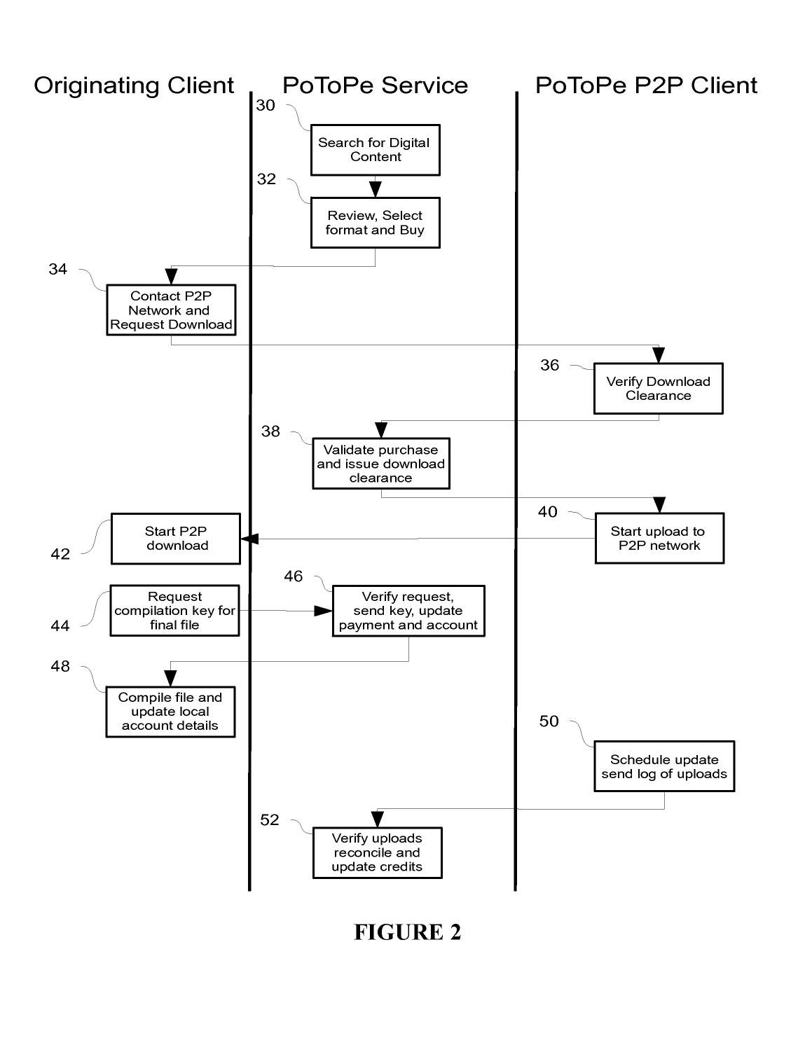

FIG. 2 exemplifies the operation of the invention once users have downloaded and installed the client application, registered with the central server 18, and deposited an initial balance on their personal account.

### Search for Digital Content 30

Users may search to locate digital content of interest to them, such as, but not limited to, digital content including movies, music, books, software, reports and images.

### Review, Select Format and Buy Digital Content 32

Users browse available digital content, select an item of interest and the relevant format and request to purchase the content, either using existing account credit or topping up their account by credit card if required.

### Contact P2P Network and Request Download 34

The central server 18 will present the local application with a prioritised list of sources and file parts for downloading the purchased digital content. The local client application will send a request to members of the P2P community 10, 12, 20 which hold a copy of the requested content to be purchased and attempt to begin downloading data packets with high priority status.

### Verify Download Clearance 36

Each P2P client which has been contacted with a download request will query the central Server 18 to obtain approval and subsequently begin uploading content

### Validate Purchase and Issue Download Clearance 38

The central server 18 will validate that the request comes from an authorised user and that payment has been authorised for the requested material and issue clearance to each uploading client.

### Start Upload to P2P Network 40

Once clearance has been received, each uploading client will begin uploading data packets of the requested file to the originating client. Each data packet is checked for integrity, confirmed as received, and logged locally by both sending and receiving clients.

Start Download from P2P Network 42

As uploading clients are identified and cleared the originating client will begin downloading content from the P2P network. One or more dedicated ‘super-client’ servers 42 will be available to ensure that new digital material can be seeded into the P2P network.

### Request Compilation Key for Final File 44

Once all data packets of the requested file have been received the originating client will issue a request to the central server 18 for a compilation key to complete the file and render it usable.

### Verify Request, Send Key, Update Payment and Account 46

On receipt of the request for a compilation key, the central server 18 will again verify that the originating client has a legitimate right to the content, issues a final compilation key, and moves funds from pending status to paid status allowing payment to be made to content providers and updating the client's user account.

### Complete File and Update Local Account Details 48

On receipt of compilation key, the file will be rendered usable and local account details are updated to reflect the purchase of digital content. The compilation key may be requested multiple times if required as it will only ever be relevant to a single purchase.

### Scheduled Update Send Log of Uploads 50

Periodically, the local application will send a log of all successful data packet ‘uploads’ to the central server, including details of the date, data content, size of upload, user id of recipient etc.

### Verify Uploads, Reconcile and Update Credits 52

On receipt of an upload log, the central server will validate the sender's details, check the transaction log, reconcile with purchases made and records received from downloaders, and update the credit record for the uploading member based on the proportion/size of file uploaded and the credit value for that content at the time.

It will be apparent to those in the art that this embodiment of the invention has advantages over the prior art by allowing the reconciliation of user accounts on the P2P network while ensuring that the P2P network is not overloaded with overhead traffic when digital content is being shared between users. In particular, the invention enables the maintenance of accurate checks on whether legitimate content is being shared and the amounts and types of data packets being transferred between originating and seeding clients by reconciling a user's accounts with the central server, periodically, on a delayed basis in a sequence determined by the central server 18. Therefore, the invention allows a commercial peer-to-peer network to operate efficiently, while minimising the disruption caused by reconciling a user's account with the central server in real-time. It should be noted that the invention anticipates that the user may request to view a real-time estimation of earned rewards using locally-available upload data prior to a reconciliation of the transaction log with other members via the central server 18, if desired.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method for facilitating a commercial distributed peer-to-peer network including the steps of:
(a) providing means to allow registered members to download authorised content via a transaction with a central server which may either (i) be paid for (ii) be free of charge; or (iii) earning credits;
(b) providing means for at least part of said content to be uploaded from one or more said members who are online who hold copies of the said content locally on their own computers;
(c) providing means to verify the legitimacy of download requests with said central server prior to commencing upload from said members holding copies of the requested content.

2. The method of claim 1 further including the steps of:
(a) providing means to maintain a detailed transaction log for each member with details of all downloading, uploading and other activities engaged in as part of the peer-to-peer network;
(b) providing means for uploading said transaction log to said central server in order to reconcile the transaction log for said members, on a delayed basis.

3. The method of claim 2 further including the steps of:
(a) providing means for members to view a real-time estimation of earned rewards using locally available upload data prior to being reconciled with logs of downloads to other members through said central server;
(b) providing the facility to reconcile the logs of all individual users' activities through said central server;
(c) allocating appropriate credit and debit charges to at least one member's account to reflect the exact details and volumes of digital traffic which have taken place and ensure that each transaction is matched and validated between uploading and downloading members;
(d) providing the facility to control and prioritise the location of uploading members and sequence of file parts transmitted for any one file download in real-time according to a combination of performance and financial considerations;
whereby a balance of speed of downloads for buyers and equable distribution of rewards for sellers in a secure environment is maintained.

4. The method of claim 2 further including the steps of:
(a) providing means for said members to send an automated email recommending non-members to join or members and non-members to sample and buy said content;
(b) providing a central server to track the progress of all such recommendations issued and allocate credits or rewards to the issuing member if: (i) the recipient acts upon the email and views the recommended content on the central site and, (ii) the recipient opens an account with the facility; and (iii) the recipient purchases or downloads the recommended content.

5. The method of claim 3 further including the step of providing means for the members of the peer-to-peer network to retain all or part of rewards earned by members to fund other community services.

6. A method for facilitating a commercial distributed peer-to-peer network, comprising:
(a) providing means to maintain a detailed local transaction log for each item of authorised digital content by tracking the number of downloads made by date and user;
(b) providing means to maintain a account for each provider of authorised content and allocate a credit or debit to an account for each complete download of specific content related to that provider;
(c) providing means for uploading said local transaction log to central server, on a delayed basis, to in order to reconcile the account details for said provider;
(d) providing means for said provider to view their account details at any time and view history and volumes of content downloads as well as current balance, credits and debits applied to their account.
